(19) United States
(12) Patent Application Publication
(10) Pub. No.: US 2011/0061023 A1
(43) Pub. Date: Mar. 10, 2011

(54) ELECTRONIC APPARATUS INCLUDING TOUCH PANEL AND DISPLAYING METHOD OF THE ELECTRONIC APPARATUS

(75) Inventor: Myeong-ho Kim, Suwon-si (KR)

(73) Assignee: Samsung Electronics Co., Ltd., Suwon-si (KR)

(21) Appl. No.: 12/878,140

(22) Filed: Sep. 9, 2010

(30) Foreign Application Priority Data
Sep. 9, 2009 (KR) 10-2009-0085067

(51) Int. Cl. G06F 3/041; G06F 3/048

(52) U.S. Cl. 715/810; 345/173

(57) ABSTRACT

An electronic apparatus includes a touch panel that displays an image and detects a touch manipulation to a surface of the touch panel, and a controller that controls the touch panel to change the image displayed by the touch panel according to a characteristic of the touch manipulation detected by the touch panel. A displaying method of the electronic apparatus includes detecting a touch manipulation to a surface of the touch panel, generating a position signal indicating a position where the touch manipulation detected in the detecting operation is performed, generating a characteristic signal indicating the characteristic of the touch manipulation, and changing an image displayed on the touch panel according to the characteristic signal.

### CROSS-REFERENCE TO RELATED PATENT APPLICATION

This application claims the priority benefit of Korean Patent Application No. 10-2009-0085067, filed on Sep. 9, 2009, in the Korean Intellectual Property Office, the disclosure of which is incorporated herein in its entirety by reference.

### BACKGROUND

1. Field of the Invention

The present invention relates to an electronic apparatus including a touch panel and a displaying method of the electronic apparatus, and more particularly, to an electronic apparatus including a touch panel which changes an image according to the characteristic of a touch manipulation, and a displaying method of the electronic apparatus.

2. Description of the Related Art

Electronic apparatuses including a touch panel may conveniently perform various functions by a user touching a surface of the touch panel with a finger or stylus. The touch panel provides an environment by which a user may instinctively manipulate the electronic apparatuses, and thus, the touch panel may be used in various electronic apparatuses such as digital cameras, portable media players (PMPs), navigation devices, and public guidance devices using flat display devices.

Users using a touch panel typically select execution menus with the finger, etc., while viewing the executable menus displayed on the touch panel. When electronic apparatuses using a touch panel are designed, the arrangement and displaying order of execution menus, which are related to touch manipulation, are important factors in order to conveniently use the electronic apparatuses. However, general electronic apparatuses including a touch panel only check the execution of a touch manipulation, and a function corresponding to a menu selected by the touch manipulation is simply performed. Thus, user interfaces related to the checked touch manipulation are limited.

### SUMMARY

Embodiments of the present invention provide an electronic apparatus including a touch panel in which an application scope is widened so that the electronic apparatus is conveniently used, and a displaying method of the electronic apparatus.

Embodiments of the present invention also provide an electronic apparatus including a touch panel that provides a user interface according to a pressure, contact area or contact time of touching the touch panel, and a displaying method of the electronic apparatus.

Embodiments of the present invention also provide an electronic apparatus that is controlled as aesthetically desired by a user using a touch panel so that a user interface of the electronic apparatus is conveniently used.

Embodiments of the present invention also provide an electronic apparatus including a touch panel that changes an image according to the characteristic of a touch manipulation, and a displaying method of the electronic apparatus.

According to an aspect of the present invention, an electronic apparatus includes a touch panel that displays an image and detects a touch manipulation to a surface of the touch panel, and a controller that controls the touch panel to change the image displayed by the touch panel according to a characteristic of the touch manipulation detected by the touch panel.

The touch panel may detect a position where the touch manipulation is performed to generate a position signal, and may generate a characteristic signal representing the characteristic of the touch manipulation by sensing at least one of a pressure under which the surface of the touch panel is touched, a contact area of the surface of the touch panel, and a contact time.

The electronic apparatus may further include a vibration-generating device that generates vibration, wherein the controller adjusts a strength of the vibration generated by the vibration-generating device according to the characteristic signal of the touch panel.

The controller may control the touch panel according to the characteristic signal of the touch panel so as to change a size of a menu included in the image displayed on the touch panel.

The controller may control the touch panel according to the characteristic signal of the touch panel so as to change a velocity of displaying a menu included in the image displayed on the touch panel.

The controller may control the touch panel according to the characteristic signal of the touch panel so as to change a color of a menu selected from among menus displayed on the touch panel.

The electronic apparatus may further include a memory that stores images, wherein the controller controls the touch panel so that the images stored in the memory are sequentially displayed, and controls a velocity of changing the images displayed on the touch panel according to the characteristic signal of the touch panel.

The electronic apparatus may further include a lens assembly including a plurality of lenses; an image pickup unit that captures image light passing through the lens assembly and converts the image light into image data to be displayed on the touch panel; and a lens adjuster that adjusts relative positions of the lenses, wherein the controller controls the lens adjuster according to the characteristic of the characteristic signal of the touch panel.

According to another aspect of the present invention, a displaying method of an electronic apparatus includes a detecting operation of detecting a touch manipulation to a surface of a touch panel; a signal generating operation of generating a position signal indicating a position where the touch manipulation detected in the detecting operation is performed, and a characteristic signal indicating a characteristic of the touch manipulation; and an image changing operation of changing an image displayed on the touch panel according to the characteristic signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an electronic apparatus including a touch panel, according to an embodiment of the present invention;

FIG. 2 is a schematic diagram for explaining a principle of operating the touch panel of the electronic apparatus of FIG. 1, according to an embodiment of the present invention;

FIG. 3 is a flowchart of a displaying method of the electronic apparatus of FIG. 1, according to an embodiment of the present invention;

FIG. 4 is a conceptual diagram for explaining an operation of the touch panel of the electronic apparatus of FIG. 1, according to an embodiment of the present invention;

FIG. 5 is a conceptual diagram for explaining an operation of the touch panel of the electronic apparatus of FIG. 1, according to another embodiment of the present invention;

FIG. 6 is a conceptual diagram for explaining an operation of the touch panel of the electronic apparatus of FIG. 1, according to another embodiment of the present invention;

FIG. 7 is a conceptual diagram for explaining an operation of the touch panel of the electronic apparatus of FIG. 1, according to another embodiment of the present invention;

FIG. 8 is a block diagram of an electronic apparatus including a touch panel, according to another embodiment of the present invention;

FIG. 9 is a flowchart of a displaying method of the electronic apparatus of FIG. 8, according to another embodiment of the present invention; and

FIG. 10 is a conceptual diagram for explaining an operation of a touch panel operating according to the displaying method of FIG. 9, according to an embodiment of the present invention.

### DETAILED DESCRIPTION

Hereinafter, an electronic apparatus including a touch panel and a displaying method of the electronic apparatus will be described with regard to exemplary embodiments of the invention and with reference to the attached drawings.

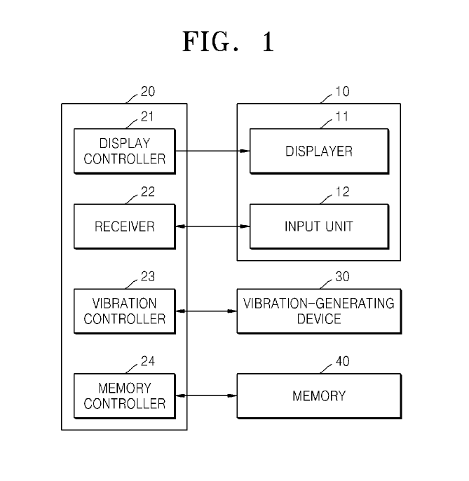

FIG. 1 is a block diagram of an electronic apparatus including a touch panel 10, according to an embodiment of the present invention.

Referring to FIG. 1, the electronic apparatus includes the touch panel 10 for displaying an image and detecting a touch manipulation to a surface of the touch panel 10, and a controller 20 for controlling the touch panel 10 so as to change the image displayed on the touch panel 10 according to characteristics of the touch manipulation detected by the touch panel 10. The electronic apparatus may be used as a digital camera, a portable media player, etc.

The touch panel 10 may be installed on various electronic apparatuses such as digital cameras, navigation devices, or portable media players (PMPs), in order to improve the user's manipulation convenience. The touch panel 10 is an input device for replacing a keyboard, a mouse, buttons, etc. Since a desired operation may be performed by touching the surface of the touch panel 10 with a finger or stylus, the touch panel 10 may facilitate an instinctive operation under a graphic user interface (GUI) environment.

A user may enjoy viewing an image through the touch panel 10, and may select or execute various menus displayed on the touch panel 10 by touching the touch panel 10 with a finger or stylus. The touch panel 10 includes a displayer 11 that displays the image. An input unit 12 is disposed on the displayer 11, and detects a touch manipulation of the touch panel 10.

The controller 20 is electrically connected to the touch panel 10, a vibration-generating device 30 and a memory 40. In order to control operations of the touch panel 10, the vibration-generating device 30, and the memory 40, the controller 20 may transmit and receive control signals to and from the touch panel 10, the vibration-generating device 30, and the memory 40, or may process data. The controller 20 may include a display controller 21, a receiver 22, a vibration controller 23, and a memory controller 24.

The controller 20 may be embodied by a microchip or a circuit board including the microchip. Each component included in the controller 20 may be embodied by software included in a circuit board, a microchip, or circuits.

The displayer 11 is a display device controlled by the display controller 21 so as to display an image. Examples of the displayer 11 may include, but are not limited to, a liquid crystal display (LCD), a plasma display panel (PDP), an electroluminescent (EL) display device, or a field emission (FE) device.

The memory 40 is a storage in which an image or program to be displayed on the displayer 11 is stored. The memory 40 includes a semiconductor memory device such as synchronous dynamic random access memory (SDRAM), and functions as a recording medium for storing data of a captured image. The memory controller 24 controls recording the data of the captured image to the memory 40, and reading the data of the captured image from the memory 40 or setting information recorded in the memory 40.

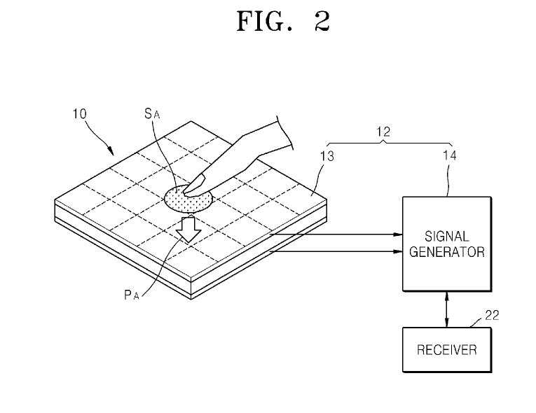

FIG. 2 is a schematic diagram for explaining a principle of operating the touch panel 10 of the electronic apparatus of FIG. 1, according to an embodiment of the present invention.

An input unit 12 is disposed on the displayer 11, and detects a touch manipulation to a surface of the input unit 12. The input unit 12 may generate a characteristic signal indicating a characteristic of the touch manipulation and a position signal indicating a position where the touch manipulation is performed. Various technologies such as a resistance detecting type, surface wave detecting type or a capacitance detecting type may be used in the input unit 12.

The input unit 12 may include a resistance layer 13 disposed on a surface of the displayer 11, and a signal generator 14 that is electrically connected to the resistance layer 13 and generates a signal. The signal generator 14 detects at least one of a pressure P_{A} at which the surface of the touch panel 10 is touched, a contact area S_{A} on which a touch manipulation is performed, and a contact time during which the touch is performed, and generates a characteristic signal indicating the characteristic of the touch manipulation. For example, when the resistance layer 13 is compressed by the touch manipulation, the signal generator 14 may calculate a contact resistance based on the contact area S_{A}, and generate the characteristic signal. The generated characteristic signal is transmitted to the receiver 22 of the controller 20.

According to the present embodiment, the resistance layer 13 of the input unit 12, as a separate element, is disposed on the surface of the displayer 11, but the present invention is not limited thereto. For example, the resistance layer 13 of the input unit 12 may be disposed to form a transparent surface covering liquid crystal if the displayer 11 is an LCD.

Referring back to FIG. 1, the electronic apparatus including the touch panel may further include the vibration-generating device 30. The vibration-generating device 30 is controlled by the vibration controller 23 of the controller 20, so as to adjust the strength of the generated vibration of the vibration-generating device 30. The vibration controller 23 may control the vibration-generating device 30 according to the characteristic signal indicating the touch manipulation detected by the touch panel 10. For example, as a pressure of the touch manipulation is increased, the strength of the vibration may be increased. As a contact area of the touch manipulation is increased, the strength of the vibration may be increased. In addition, as a contact time of the touch manipulation is increased, the strength of the vibration may be increased.

By adjusting the strength of the vibration generated by the vibration-generating device 30 according to the characteristic of the touch manipulation, a user may feel vibration in response to the user's touch manipulation. Thus, it is convenient to manipulate the electronic apparatus using a GUI.

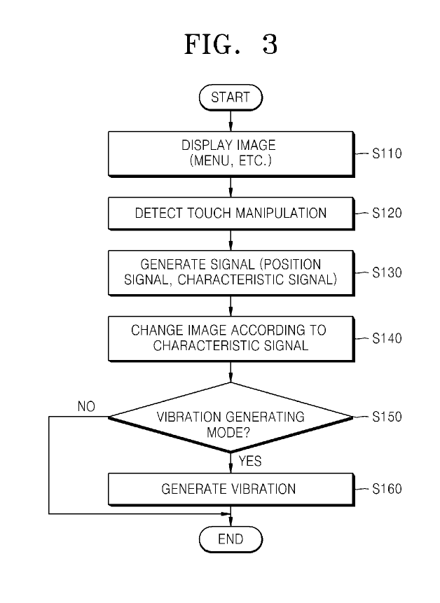

FIG. 3 is a flowchart of a displaying method of the electronic apparatus of FIG. 1, according to an embodiment of the present invention.

Referring to FIG. 3, the displaying method includes an image displaying operation (operation S110) of displaying an image on a touch panel; a touch manipulation detecting operation (operation S120) of detecting a touch manipulation to a surface of the touch panel; a signal generating operation (operation S130) of generating a position signal indicating a position of the touch manipulation and a characteristic signal indicating the characteristic of the touch manipulation; and an image changing operation (operation S140) of changing the image displayed on the touch panel according to the characteristic signal of the touch manipulation.

An image including a menu, a picture, etc., is displayed on the touch panel of the electronic apparatus (operation S110). A user may select the menu displayed on the touch panel, or may perform the touch manipulation of selecting a portion of the picture. In the touch manipulation detecting operation (operation S120), the touch manipulation is detected.

In the signal generating operation (operation S130), the characteristic signal indicating the characteristic of the detected touch manipulation and the position signal indicating a position of the touch manipulation are generated. The characteristic signal is a signal including at least one of a pressure at which the surface of the touch panel is touched, a contact area on which a touch manipulation is performed, and a contact time during which the touch manipulation is performed.

In the image changing operation (operation S140), the image displayed on the touch panel is changed according to the characteristic signal generated in the signal generating operation (operation S130). In the image changing operation (operation S140), the size of the menu included in the image, the moving velocity of the menu, and a color of the menu may be changed.

The display method of the electronic apparatus may further include a vibration generating operation (operation S160) of generating vibration. If the electronic apparatus is set to be in a mode for generating vibration (operation S150), the strength of the vibration may be adjusted according to the characteristic signal of the touch panel, which is generated in the signal generating operation (operation S130).

According to the displaying method of the electronic apparatus, the user may feel the vibration in response to the user's touch manipulation or see a change in the image. Accordingly, it is convenient to manipulate the electronic apparatus using a GUI.

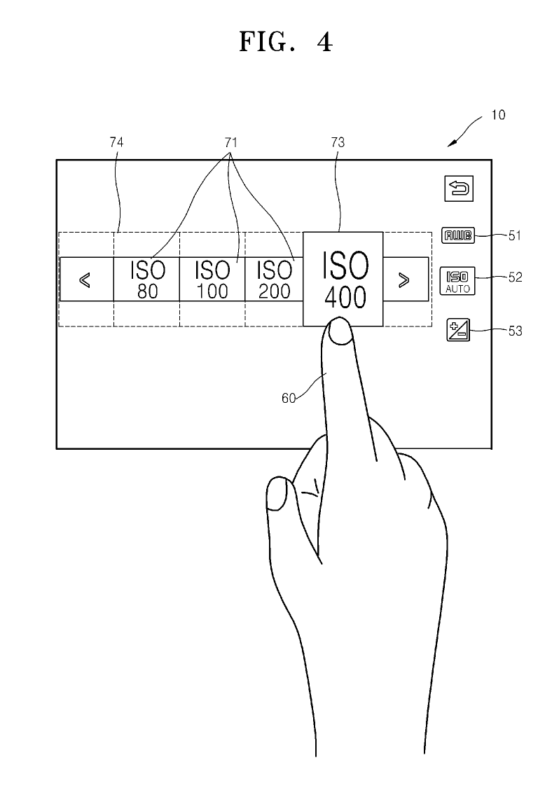

FIG. 4 is a conceptual diagram for explaining an operation of the touch panel 10 of the electronic apparatus of FIG. 1, according to an embodiment of the present invention. FIG. 4 illustrates a state of the touch panel 10 where an ISO setting menu 52 disposed between a white balance menu 51 and a fluctuation-adjusting menu 53 has been selected.

When the ISO setting menu 52 is selected, subordinate menus 71 corresponding respectively to ISO setting functions are displayed by being unfolded in a horizontal direction of the touch panel 10. The subordinate menus 71 are arranged in the horizontal direction of the touch panel 10. A velocity of displaying the subordinate menus 71 by unfolding them in the horizontal direction of the touch panel 10 may be controlled by the characteristic of the touch manipulation of pressing the ISO setting menu 52. In order to perform this function, the display controller 21 may control the touch panel 10 according to the characteristic signal so as to increase or reduce the velocity of displaying the subordinate menus 71.

When the user touches a detection region 74 divided so as to correspond to the subordinate menus 71, at least one of the subordinate menus 71, which corresponds to a portion of the detection region 74 where a touch manipulation is detected, is selected. The selected subordinate menu of the subordinate menus 71 may be enlarged to an enlarged menu 73, and then the enlarged menu 73 may be displayed. When the enlarged menu 73 is displayed, the display controller 21 may control the touch panel 10 so as to increase or reduce a velocity of displaying the subordinate menus 71 according to the characteristic signal generated by detecting the touch manipulation performed on the selected subordinate menu of the subordinate menus 71. Thus, for example, when the user strongly touches the subordinate menus 71, the enlarged menu 73 may be displayed so as to have a larger size than normal.

According to an operation of the touch panel 10 of the present embodiment, even if the subordinate menus 71 are displayed so as to have a small size, the selected subordinate menu of the subordinate menus 71, which is selected by a contact of a finger 60 on the detection region 74, is changed to the enlarged menu 73 having a large size, and thus the user may easily perform the touch manipulation, and may easily recognize the selected subordinate menu through the enlarged menu 73.

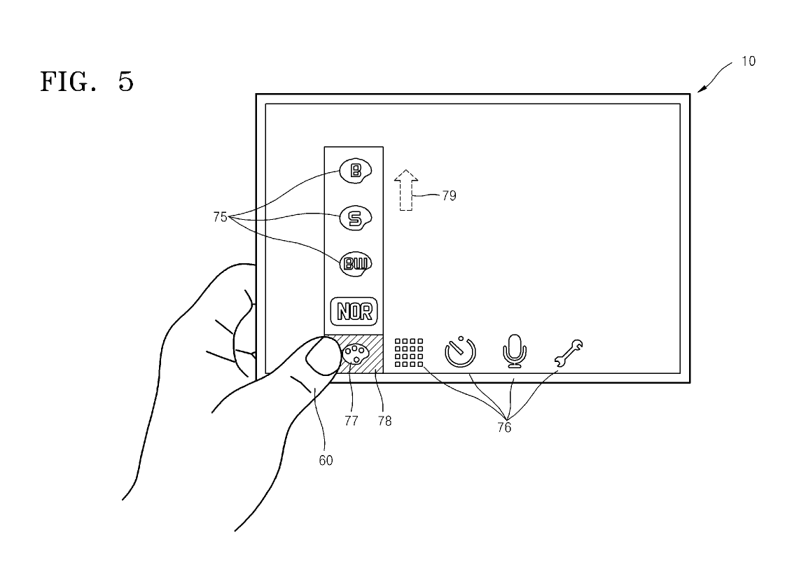

FIG. 5 is a conceptual diagram for explaining an operation of the touch panel 10 of the electronic apparatus of FIG. 1, according to another embodiment of the present invention.

Referring to FIG. 5, subordinate menus 75 for guiding a user to select a function to be performed are displayed on the touch panel 10 in a vertical direction of the touch panel 10.

Superior menus 77 and 76 are arranged close to a lower edge of the touch panel 10 in a horizontal direction of the touch panel 10. FIG. 5 illustrates a case where a user selects a filter-setting menu 77 of the superior menus 77 and 76. When a finger 60 of the user touches a detection region 78 so as to select the filter-setting menu 77, the display controller 21 of FIG. 1 may change a color of the detection region 78 surrounding the filter-setting menu 77 according to the characteristic signal generated by the touch panel 10. For example, as a pressure of the touch manipulation becomes stronger, which is determined according to the characteristic signal, the color of the detection region 78 may be displayed so as to have a darker color than normal.

When the filter-setting menu 77 is selected, at least one of the subordinate menus 75, corresponding to a filter setting function, is displayed in a column extending in a direction indicated by an arrow 79 from a position corresponding to the filter-setting menu 77. The subordinate menus 75 may be arranged in a vertical direction of the touch panel 10.

A velocity of displaying the subordinate menus 75 by unfolding them in the vertical direction of the touch panel 10 may be controlled by the characteristic of the touch manipulation of pressing the filter-setting menu 77. In order to perform this function, the display controller 21 may control the touch panel 10 according to the characteristic signal so as to increase or reduce the velocity of displaying the subordinate menus 75.

According to an operation of the touch panel 10 according to the present embodiment, the colors and displaying velocity of menu items are changed according to the characteristic of the touch manipulation, and thus the user may easily perform the touch manipulation, and may easily recognize an enlarged menu.

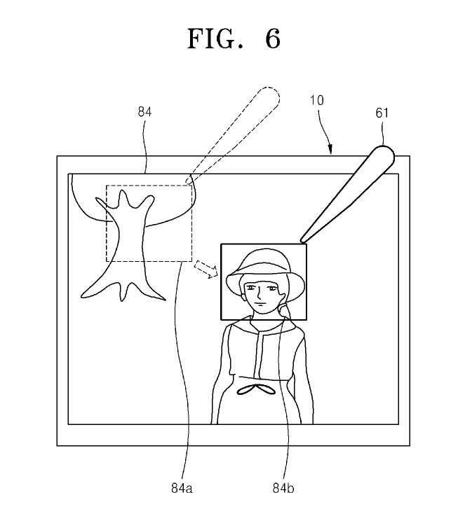

FIG. 6 is a conceptual diagram for explaining an operation of the touch panel 10 of the electronic apparatus of FIG. 1, according to another embodiment of the present invention. FIG. 6 illustrates an operation of selecting a portion of an image 84 stored in the electronic apparatus in order to enlarge or edit the image 84 in the touch panel 10.

By performing a touch manipulation to a surface of the touch panel 10 with a touch panel pen 61, the portion of the image 84 displayed on the touch panel 10 may be selected. The touch manipulation of the touch panel 10 may be performed using a drag touch method that is performed by moving the touch panel pen 61 against the surface of the touch panel 10 by a predetermined distance.

The user performs the drag touch method with the touch panel pen 61 so as to select a first portion of the image 84 including a tree, and then a square indication 84a indicating the first region is displayed on the touch panel 10.

When the user selects the square indication 84a positioned on the first region with the touch panel pen 61, and moves the square indication 84a to a second region including a human's face, a square indication 84b indicating the second region is indicated by the touch manipulation. In order to move a square indication, the display controller 21 may control the touch panel 10 according to the characteristic signal of the touch panel 10 so as to increase or reduce a velocity of moving the square indication.

When the square indications 84a and 84b are indicated by selecting portions of the image 84 by using a drag touch method, a velocity of displaying the square indications 84a and 84b may be increased or reduced according to the characteristic signal of the touch panel 10.

According to an operation of the touch panel 10 of the present embodiment, a velocity of moving a square indication displayed on the touch panel 10 is changed according to the characteristic of the touch manipulation, and thus the user may easily perform the touch manipulation, and may easily recognize a selected portion.

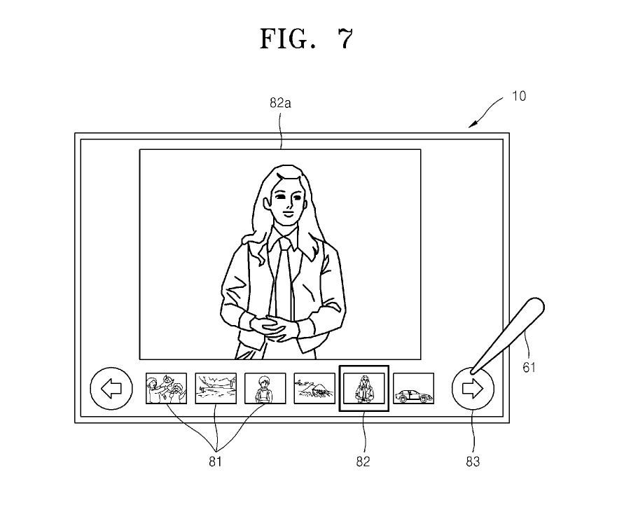

FIG. 7 is a conceptual diagram for explaining an operation of the touch panel 10 of the electronic apparatus of FIG. 1, according to another embodiment of the present invention. FIG. 7 illustrates a case where a function of sequentially displaying images 81 and 82 stored in the electronic apparatus is performed.

Electronic apparatuses such as digital cameras or PMPs may have a function of displaying captured images on a display device. A function of sequentially and automatically reproducing images stored in the electronic apparatus is referred to as a slide view function.

The electronic apparatus may sequentially and automatically reproduce a plurality of images stored in a storage device such as a memory. In addition, the electronic apparatus may sequentially reproduce a plurality of images when a user touches or selects a selection icon 83 displayed on the touch panel 10 with the touch panel pen 61. The former reproducing method refers to an automatic reproducing function, and the latter reproducing method refers to a manual reproducing function.

During the performing of the automatic reproducing function or the manual reproducing function, the user may adjust a time taken to change the images 81 by changing the strength (a contact pressure, a contact area, or a contact time) of the touch manipulation with the selection icon 83. In FIG. 7, a single thumbnail image (corresponding to the image 82) of a plurality of thumbnail images (corresponding to the images 81 and 82) is displayed as an output image 82a. In this case, for example, when the touch panel pen 61 is strongly pressed against the selection icon 83, subsequent images may be quickly changed.

According to an operation of the touch panel 10 of the present embodiment, since a velocity of changing images displayed on the touch panel 10 is changed according to a user's intention, a slide view function may be conveniently used.

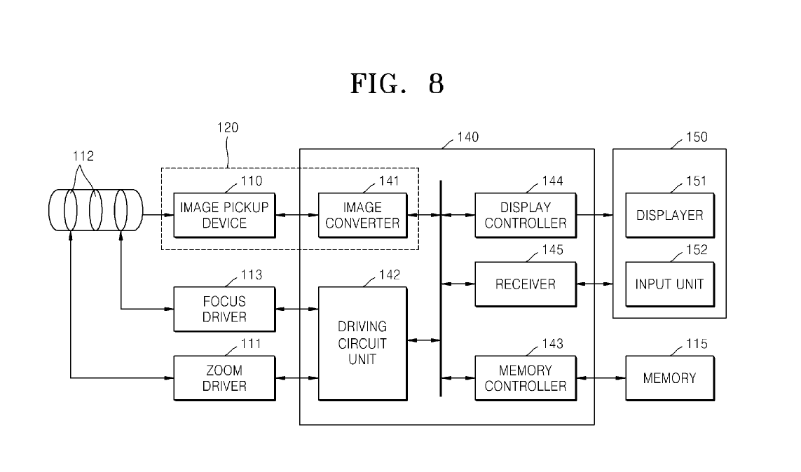

FIG. 8 is a block diagram of an electronic apparatus including a touch panel 150, according to another embodiment of the present invention.

FIG. 8 illustrates an example where the electronic apparatus of FIG. 1 is embodied as a digital camera. The electronic apparatus includes the touch panel 150 for displaying an image and detecting a touch manipulation to a surface of the touch panel 150, a controller 140 for controlling the touch panel 150 so as to change the image displayed on the touch panel 150 according to the characteristics of the touch manipulation detected by the touch panel 150, a memory 115, a lens assembly 112 including a plurality of lenses, an image pickup unit 120 for capturing image light passing through the lens assembly 112 and converting the image light into image data to be displayed on the touch panel 150, a zoom driver 111, and a focus driver 113.

The image pickup unit 120 includes an image pickup device 110 for capturing an image of a subject and converting the image into an electrical signal, and an image converter 141 for converting the electrical signal of the image pickup device 110 into the image data.

The lens assembly 112 disposed in front of the image pickup device 110 includes the lenses, and images external image light on an image pickup surface of the image pickup device 110. The lenses are arranged at variable intervals. When the intervals between the lenses are changed, the zoom magnification ratio and focus of the lens assembly 112 may be adjusted.

The intervals between the lenses may be changed by controlling the lenses by the focus driver 113 and a zoom driver 111 including a driver such as a zoom motor or a focus motor. The lenses may include a zoom lens for enlarging or reducing the size of the subject, and a focus lens for adjusting a focus on the subject. The zoom driver 111 and the focus driver 113 operate by a control signal output from a driving circuit unit 142 of the controller 140. Thus, the zoom driver 111 may drive the lens assembly 112 to have one of a plurality of magnification ratios.

The zoom driver 111 and the focus driver 113 are collectively an example of a lens adjuster for adjusting relative positions of the lenses. The present invention is not limited to the lens adjuster, and thus the lens adjuster may have various forms. For example, the lens adjuster may be embodied as a shake corrector for adjusting relative positions of the lenses in order to correct a shake.

The image pickup device 110 includes a photoelectric transformation element such as a charge-coupled device (CCD) or a complementary metal-oxide semiconductor (CMOS), and converts the image light emitted through the lens assembly 112 into an image signal that is an electrical signal. A method of converting the image light into the electrical signal may be performed by signal processing operations including converting the image light into an analog signal, converting the analog signal into a digital signal, correcting pixel errors with respect to a digital signal, performing gain correction, and performing gamma correction.

The controller 140 is electrically connected to the image pickup device 110, the zoom driver 111, the focus driver 113, the touch panel 150, and the memory 115. In order to control operations of the image pickup device 110, the zoom driver 111, the focus driver 113, the touch panel 150, and the memory 115, the controller 140 may transmit and receive control signals to and from the image pickup device 110, the zoom driver 111, the focus driver 113, the touch panel 150, and the memory 115, or may process data. The controller 140 includes the image converter 141, the driving circuit unit 142, a memory controller 143, a display controller 144, and a receiver 145.

The controller 140 may be embodied by a microchip or a circuit board including the microchip. Each component included in the controller 140 may be embodied by software included in the controller 140.

The touch panel 150 may display an image captured by the image pickup device 110, and may detect a touch manipulation to the surface of the touch panel 150 to generate a signal corresponding to a detected position. The touch panel 150 includes a displayer 151 and an input unit 152.

Examples of the displayer 151 may include a LCD and organic light emitting diode (OLED) device. The displayer 151 is controlled by the display controller 144 so as to display image data generated by the image pickup unit 120 or image data stored in the memory 115.

The receiver 145 is electrically connected to the input unit 152, and may receive from the input unit 152 a characteristic signal indicating the characteristic of the touch manipulation and a position signal indicating a position where the touch manipulation is performed.

The memory controller 143 controls recording the image data in the memory 115, and reading the image data or setting information recorded in the memory 115. The memory 115 includes a semiconductor memory device such as SDRAM, and may store the image data.

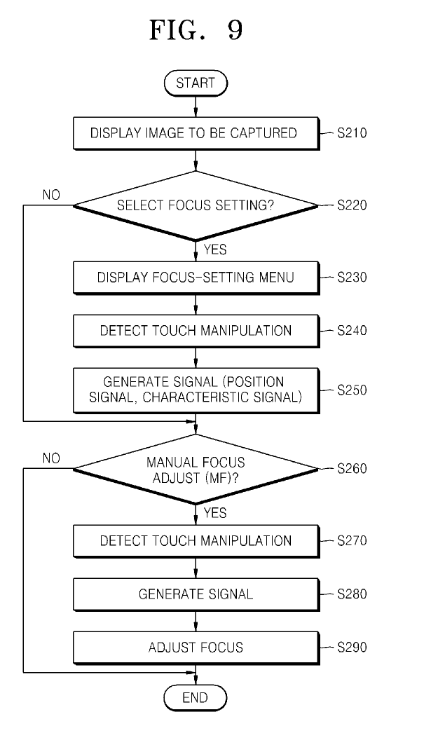

FIG. 9 is a flowchart of a displaying method of the electronic apparatus of FIG. 8, according to another embodiment of the present invention.

Referring to FIG. 9, the displaying method includes a touch manipulation detecting operation (operation S270) of detecting a touch manipulation to a surface of a touch panel; a signal generating operation (operation S280) of generating a position signal indicating a position of the touch manipulation and a characteristic signal indicating the characteristic of the touch manipulation; and a focus adjusting operation (operation S290) of adjusting a focus according to the characteristic signal of the touch panel.

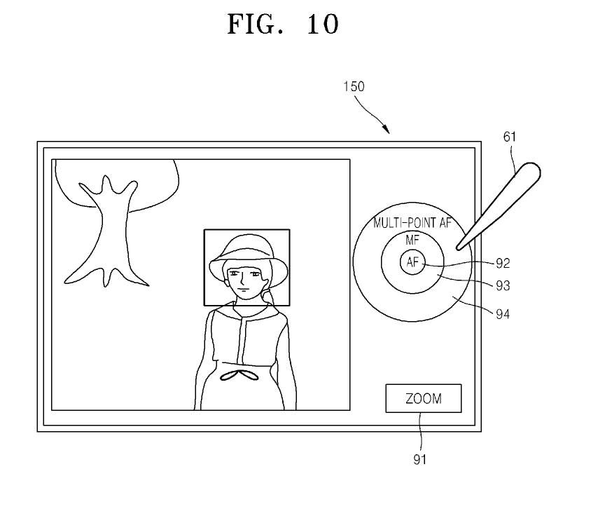

FIG. 10 is a conceptual diagram for explaining an operation of a touch panel 150 operating according to the displaying method of FIG. 9, according to an embodiment of the present invention. Hereinafter, the displaying method will be described with reference to FIGS. 9 and 10.

When a digital camera is manipulated and an image is captured, the live view displaying operation (operation S210) of displaying an image to be captured is performed. In the live view displaying operation (operation S210), image light captured by an image pickup device is converted into a live view image, and then the live view image is displayed on the touch panel 150, and thus a user may adjust the composition of an image to be captured or adjust a focus through the live view image.

When the focus setting function is selected (operation S220), focus-setting menus 92, 93 and 94 are displayed on the touch panel 150, as illustrated in FIG. 10 (operation S230). The focus-setting menus 92, 93 and 94 are a portion of an image displayed on the touch panel 150, rather than a hardware button. A focus-setting menu may include an AF menu 92 indicating an automatic focus adjusting function, a MF menu 93 indicating a manual focus adjusting function, and a multi-point AF menu 94 indicating a multi-point automatic focus adjusting function.

A user may select at least one of these focus adjusting functions by manipulating the focus-setting menus 92, 93 and 94 with the touch panel pen 61, etc. When the user touches the focus-setting menus 92, 93 and 94 of the touch panel 150, the touch manipulation detecting operation (operation S240) is performed, and then the signal generating operation (operation S250) of generating a characteristic signal indicating the characteristic (e.g., a contact pressure, a contact area, or a contact time) of the touch manipulation and a position signal indicating a position where the touch manipulation is performed.

In order to select at least one of the focus adjusting functions, a user may touch menu regions of the focus-setting menus 92, 93 and 94. Alternatively, it may be recognized that any one of the focus-setting menus 92, 93 and 94 is selected according to the characteristic signal of the touch manipulation. For example, when a pressure of the touch manipulation is the weakest, the AF menu 92 is recognized as selected. When the pressure of the touch manipulation is medium strength, the MF menu 93 is recognized as selected. When the pressure of the touch manipulation is the strongest, the multi-point AF menu 94 is recognized as selected.

In addition, for example, the focus-setting menus 92, 93 and 94 may be set to be sequentially selected according to a contact time of the touch manipulation. That is, when the focus-setting menus 92, 93 and 94 are continually pressed with the touch panel pen 61, the AF menu 92, the MF menu 93 and the multi-point AF menu 94 may be sequentially selected.

When any one of the focus-setting menus 92, 93 and 94 is selected, the color or size of a corresponding region may be changed. When the AF menu 92 or the multi-point AF menu 94 is selected, the digital camera may perform an automatic focus function using some circuits or software.

When the MF menu 93 corresponding to the manual focus function is selected (operation S260), a user may perform the focus adjusting operation (operation S290). To achieve this, the touch manipulation detecting operation (operation S270) detects when the user continually pushes the MF menu 93 of the touch panel 150. The characteristic signal generating operation (operation S280) of generating a characteristic signal indicating the characteristic of the touch manipulation is then performed.

In the focus adjusting operation (operation S290), relative intervals between lenses may be changed according to a contact time of the touch manipulation. When a desired focus state is obtained, the user stops the touch manipulation to finish a manual focus manipulation.

The focus adjusting operation (operation S290) is an example of a lens adjusting operation, but the present invention is not limited thereto. For example, the lens adjusting operation may be replaced by a zoom function of adjusting relative positions of lenses or a shake correction function of correcting a shake.

For example, the user may perform the zoom function by performing the touch manipulation with a zoom menu 91 displayed on the touch panel 150 so as to adjust relative intervals between lenses. When the touch manipulation is performed with the zoom menu 91, the touch panel 150 may generate the characteristic signal indicating the characteristic of the touch manipulation, and the digital camera may adjust the relative intervals between the lenses to perform the zoom function according to the characteristic signal.

According to the displaying method of the present embodiment, a user may see a change in an image in response to a user's touch manipulation, and may change the characteristic of the touch manipulation, such as a contact pressure, a contact area or a contact time, and thus a zoom function and a focus adjusting function may be conveniently performed.

In addition, an image displayed on a touch panel may be changed according to characteristics such as a contact pressure, a contact area or a contact time of the touch manipulation to the touch panel. Thus, since an electronic apparatus may be controlled as aesthetically desired by a user using the touch panel, the application scope of a user interface is widened, and thus the electronic apparatus may be conveniently used.

The device described herein may comprise a processor, a memory for storing and executing program data, a permanent storage such as a disk drive, a communications port for handling communications with external devices, and user interface devices, including a display, keys, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. It will be recognized that the terms “comprising,” “including,” and “having,” as used herein, are specifically intended to be read as open-ended terms of art. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

What is claimed is:

1. An electronic apparatus comprising:
a touch panel that displays an image and detects a touch manipulation to a surface of the touch panel; and
a controller that controls the touch panel to change the image displayed by the touch panel according to a characteristic of the touch manipulation detected by the touch panel.

2. An electronic apparatus comprising:
a touch panel that displays an image and detects a touch manipulation to a surface of the touch panel; and
a controller that controls the touch panel to change the image displayed by the touch panel according to a characteristic of the touch manipulation detected by the touch panel;
wherein the touch panel detects a position where the touch manipulation is performed to generate a position signal, and generates a characteristic signal representing the characteristic of the touch manipulation by sensing at least one of a pressure under which the surface of the touch panel is touched, a contact area of the surface of the touch panel, and a contact time.

3. The electronic apparatus of claim 2, further comprising a vibration-generating device that generates vibration,
wherein the controller adjusts a strength of the vibration generated by the vibration-generating device according to the characteristic signal of the touch panel.

4. The electronic apparatus of claim 2, wherein the controller controls the touch panel according to the characteristic signal of the touch panel so as to change a size of a menu included in the image displayed on the touch panel.

5. The electronic apparatus of claim 2, wherein the controller controls the touch panel according to the characteristic signal of the touch panel so as to change a velocity of displaying a menu included in the image displayed on the touch panel.

6. The electronic apparatus of claim 2, wherein the controller controls the touch panel according to the characteristic signal of the touch panel so as to change a color of a menu selected from among menus displayed on the touch panel.

7. The electronic apparatus of claim 2, further comprising a memory that stores images,
wherein the controller controls the touch panel so that the images stored in the memory are sequentially displayed, and controls a velocity of changing the images displayed on the touch panel according to the characteristic signal of the touch panel.

8. The electronic apparatus of claim 2, further comprising:
a lens assembly comprising a plurality of lenses;
an image pickup unit that captures image light passing through the lens assembly and converts the image light into image data to be displayed on the touch panel; and
a lens adjuster that adjusts relative positions of the lenses,
wherein the controller controls the lens adjuster according to the characteristic of the characteristic signal of the touch panel.

9. A displaying method of an electronic apparatus, the displaying method comprising:
a detecting operation of detecting a touch manipulation to a surface of a touch panel;
a signal generating operation of generating a position signal indicating a position where the touch manipulation detected in the detecting operation is performed, and generating a characteristic signal indicating a characteristic of the touch manipulation; and
an image changing operation of changing an image displayed on the touch panel according to the characteristic signal.

10. The displaying method of claim 9, wherein the characteristic signal generated in the signal generating operation indicates at least one of a pressure at which the surface of the touch panel is touched, a contact area of the surface of the touch panel, and a contact time.

11. The displaying method of claim 10, further comprising a vibration generating operation of generating vibration,
wherein the vibration generating operation is performed by adjusting a strength of the vibration according to the characteristic signal of the touch panel.

12. The displaying method of claim 10, wherein the image changing operation is performed by changing a size of a menu included in the image displayed on the touch panel according to the characteristic signal of the touch panel.

13. The displaying method of claim 10, wherein the image changing operation is performed by changing a velocity of displaying of a menu included in the image displayed on the touch panel according to the characteristic signal of the touch panel.

14. The displaying method of claim 10, wherein the image changing operation is performed by changing a color of a menu selected from among menus displayed on the touch panel according to the characteristic signal of the touch panel.

15. The displaying method of claim 10, further comprising an image displaying operation of sequentially displaying a plurality of images on the touch panel,
wherein a velocity of changing the images displayed on the touch panel is controlled according to the characteristic signal of the touch panel.

16. The displaying method of claim 10, further comprising:
an image pickup operation of capturing image light passing through a plurality of lenses and converting the image light into image data to be displayed on the touch panel; and
a lens adjusting operation of adjusting a relative position of the lenses according to the characteristic signal of the touch panel.
